(19) United States
(12) Patent Application Publication
(10) Pub. No.: US 2017/0156479 A1
(43) Pub. Date: Jun. 8, 2017

(54) EXERCISE MAT CARRIER AND MASSAGE ROLLER

(71) Applicant: Geoffrey Erik Kwong, Alhambra, CA (US)

(72) Inventor: Geoffrey Erik Kwong, Alhambra, CA (US)

(21) Appl. No.: 15/408,181

(22) Filed: Jan. 17, 2017

(51) Int. Cl. A45F 4/02; A61H 15/00; B65D 81/26; A45F 3/14; A63B 21/00

(52) U.S. Cl. CPC A45F 4/02; A45F 3/14; A63B 21/4037; B65D 81/266; A61H 15/00; A45F 2003/142; A45F 2004/006

(57) ABSTRACT

An exercise mat carrier includes a rigid hollow tube enclosing a space for storing a rolled-up exercise mat. At least one container holds a desiccant and is fluidly connected with the space in the rigid hollow tube for drying the exercise mat. A removable and replaceable flexible material is placed around the outside of the hollow tube allowing for its use as a massage roller. A pair of ring-shaped rolling supports encircle the rigid hollow tube for engaging in rolling contact with a surface when using the rigid hollow tube as a massage roller.

### BACKGROUND OF THE INVENTION

Modern exercise enthusiasts enjoy using various types of exercise equipment. Particularly popular are exercise mats (types of which include yoga mats, Pilates mats, or sticky mats), foam rollers (also referred to as massage rollers), and stretching tethers. For hygiene and personalization reasons, users often own their own exercise mats, massage rollers, and stretching tethers and carry them to a gym, studio, scenic outside location, or other place for exercise. Carrying all of these separate pieces of equipment, along with the usual gym bag and other items, can be inconvenient, difficult or nearly impossible.

Exercise mats can also become sweat covered after a hard workout. If left in such a condition for some time they can begin to rot, become smelly, or can even grow mold. In humid climates, even if left exposed to the open air, a sweaty mat might not dry in a timely manner.

It would be desirable to have a compact and convenient way to carry an exercise mat and a massage roller together while at the same time allowing the exercise mat to dry out rather than becoming rotten and moldy. It would also be desirable to provide removable and replaceable covers for the massage roller.

### SUMMARY OF THE INVENTION

The present invention provides a compact and convenient way to carry an exercise mat and a massage roller together, while at the same time allowing the exercise mat to dry out rather than becoming rotten and moldy. It can also include a removable and replaceable cover for covering the massage roller.

In general terms, the invention is an exercise-mat carrier and a method for carrying an exercise mat. The exercise mat carrier can include a rigid hollow tube enclosing a space for storing a rolled-up exercise mat. At least one container can hold a desiccant, with the container fluidly connected to the space in the rigid hollow tube for drying the exercise mat. A removable and replaceable flexible cover can be placed around the outside of the hollow tube for improving its use as a comfortable massage roller.

In one embodiment, the method for carrying an exercise mat can comprise the steps of rolling up the exercise mat; placing the rolled-up exercise mat within an inner space of a rigid hollow tube, placing a flexible cover around the rigid hollow tube for the rigid hollow tube to be used as a massage roller; placing desiccant within at least one container fluidly connected with the inner space in the rigid hollow tube; and allowing the desiccant to dry the rolled-up exercise mat.

### BRIEF DESCRIPTION OF THE DRAWINGS

Further preferred features of the invention will now be described for the sake of example only with reference to the following figures, in which:

FIG. 1 is a perspective view of one embodiment the exercise mat carrier of the present invention.

FIG. 2 is a perspective view of the embodiment of FIG. 1 in which a drying module is shown detached from a main rigid hollow tube.

FIG. 3a shows a diagrammatic view of the embodiment of FIG. 1.

FIG. 3b shows a diagrammatic view of the embodiment of

FIG. 3a with both drying modules unscrewed from the main rigid hollow tube.

FIG. 4 shows a diagrammatic cutaway view along the line A-A (see FIG. 2) of a ring-shaped rolling support.

FIG. 5a shows an exercise mat. FIG. 5b shows a diagrammatic view of the exercise mat inserted into the rigid hollow tube of FIG. 1 and with the drying modules unscrewed from the rigid hollow tube. FIG. 5c shows a diagrammatic view of an assembled exercise mat carrier of FIG. 1 with exercise mat enclosed therein.

FIG. 6 is a perspective view of the embodiment of FIG. 1 in which a drying module is shown detached from a main rigid hollow tube and a drying module is shown detached and further disassembled.

FIG. 7 shows a perspective view of a disassembled drying module as shown in FIGS. 1-6. FIG. 8 shows a partially assembled view of the drying module.

FIG. 9 shows another diagrammatic view of the drying module assembled and attached to the rigid hollow tube.

FIG. 10 shows a top view of the drying module of FIGS. 7-9.

FIGS. 11a and 11b show a removable and replaceable flexible cover placed around the outside of the rigid hollow tube allowing for its use as a comfortable massage roller.

FIG. 12 shows a stretching tether attached to the exercise mat carrier of FIG. 1.

FIG. 13 is a flowchart illustrating steps of a method of using the exercise mat carrier of the previous figures.

### DETAILED DESCRIPTION

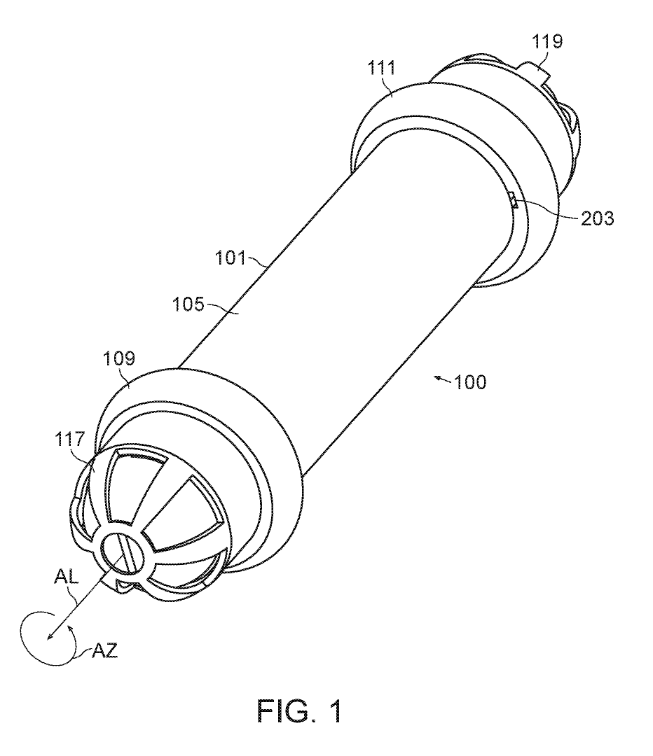

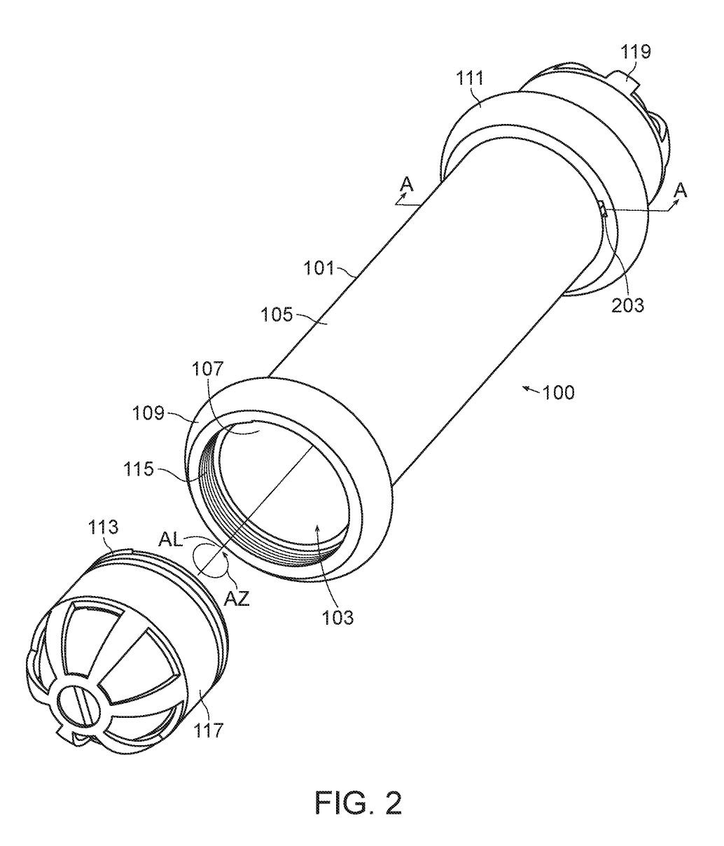

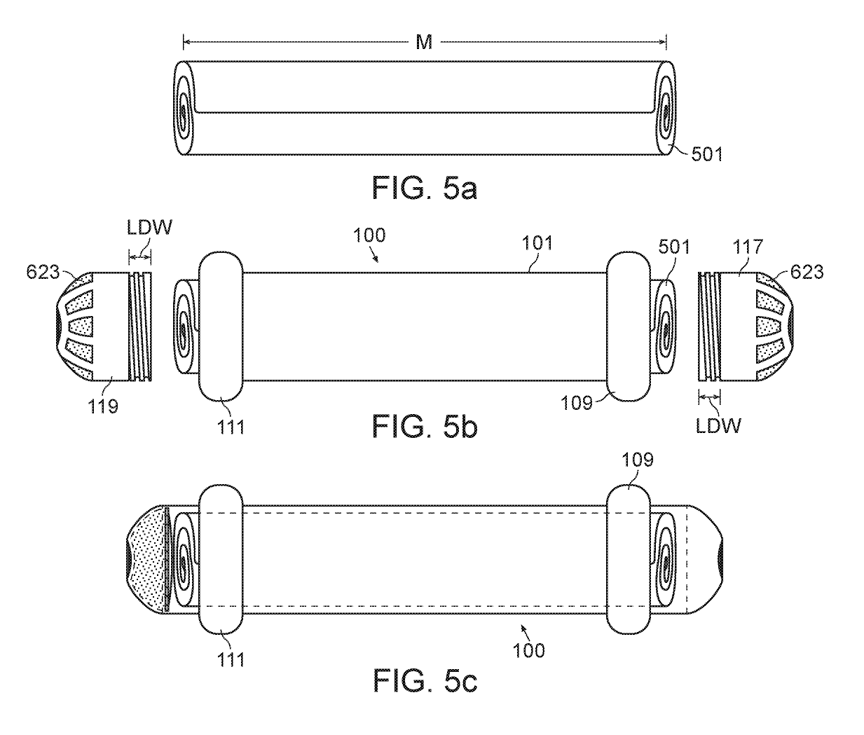

FIGS. 1 and 2 are perspective views of one embodiment of an exercise mat carrier 100 of the present invention. A rigid hollow tube 101 encloses a space 103 for storing a rolled-up exercise mat 501 (see FIG. 5). In the present embodiment, the tube 101 is additionally used as a massage roller. Massage rollers (a type of which is commonly known as a foam roller) are well known in the art and are typically used for self-myofascial release. US Patent Application publication number 20150080774 by Olaya filed on Sep. 18, 2013 is an example of such a massage roller and is hereby incorporated by reference in its entirety into the present disclosure. When used as a massage roller, the exercise mat carrier 100 is rolled between a portion of the body of a user and a surface such as the floor.

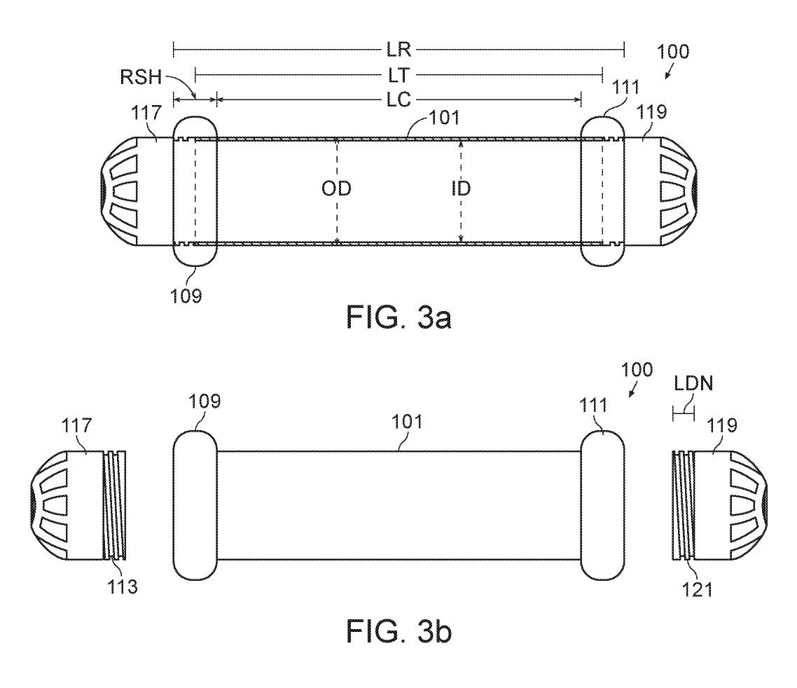

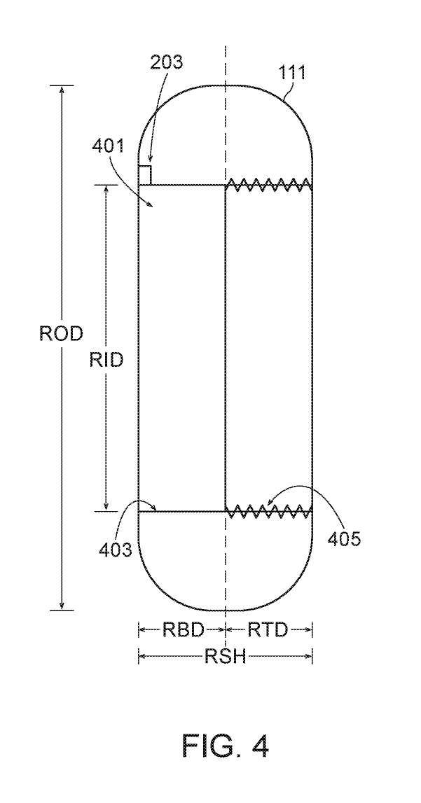

FIGS. 3a and 3b are diagrammatic views of the exercise mat carrier 100. In FIG. 3b, drying modules 117, 119 are unscrewed and separated from ring-shaped rolling supports 109, 111 and tube 101. FIG. 3b further shows the drying modules 117, 119 have drying module necks with outer male threads 113, 121 for engaging the threads of the female threaded hole 115 (see FIG. 2) and the female threaded hole 405 (see FIG. 4) of the rolling supports 109, 111. In FIG. 3a both of the drying modules 117, 119 are shown screwed into the rolling supports 109, 111 and tube 101 to form a substantially fluid-tight connection.

In one embodiment the entire exercise mat carrier 100 weighs less than 2.5 pounds.

The tube 101 has an outer tube wall 105 and an inner tube wall 107 (shown in FIG. 2). The tube 101 is preferably shaped as a cylinder having a circular cross-section, but other shapes such as that of an oval cross-section cylinder are possible. The space 103 is partially enclosed by and defined by the inner tube wall 107. The tube 101 has an inner diameter ID and outer diameter OD as illustrated in FIG. 3a. In one embodiment, the inner diameter ID can be at least 5 inches, thereby allowing for the insertion of a full-sized rolled-up exercise mat into the tube 101. Also, the outer diameter OD can be from slightly more than 5 inches to 7 inches, making it particularly comfortable and effective as a massage roller. The tube 101 can have a length LT of 19 inches as shown in FIG. 3a.

The tube 101 can be constructed of high strength lightweight composites. For example, the tube 101 can be constructed of CFRP carbon fiber reinforced plastic. Extruded aluminum anodized tubing with silver oxide antimicrobial properties can also be used. The antimicrobial properties are helpful for preventing microbes from forming on the inner tube wall 107 due to contact with a wet or moist exercise mat 501 (see FIG. 5a).

The tube can also be made from bamboo pulp fiber (for example Model Number OBI-F100400F from ORGANIC BAMBOO INDUSTRIES AG of Fujian, China). The bamboo pulp fiber is mixed with epoxy or resin and injection molded to make a strong and light tube.

It is useful for the tube material to allow the walls of the tube 101 to be strong and thin. For example, a strong and thin material allows the walls of the tube 101 to have a thickness of approximately 4-10 mm (approximately 0.15-0.40 inches). It is also helpful for tube 101 to be light weight for easy carrying. At the same time the strength of the material allows the tube 101 to support at least 300 lbs of weight resting on it.

In other embodiments the outer diameter OD can be between 3 inches and 8 inches and the length LT can be between 15 inches and 24 inches. Providing a tube 101 with a larger OD allows for thicker walls and the tube can be stronger. Alternatively, providing a tube 101 with a larger outer diameter OD can allow for a larger inner diameter and thus a larger space 103 for storing more items and/or a larger exercise mat.

At opposite ends of the tube 101 are the substantially identical ring-shaped rolling supports 109, 111 sharing a common longitudinal axis AL with the tube 101 and encircling the tube 101 in an azimuthal direction AZ (see FIG. 2). As shown in FIG. 3a, when attached to the tube 101, there is a distance LC between the rolling supports 109, 111. The distance LC can be 17 inches which is a good width for a 17 inch×6 inch massage roller and is wide enough for a user to massage a section of their body against.

When used as a massage roller, the drying modules 117, 119 are usually, but not necessarily, unscrewed and separated from the ring-shaped rolling supports 109, 111 and tube 101. As shown in FIG. 3b, with the drying modules 117, 119 removed, the massage roller (the tube 101 and rolling supports 109, 111 together) has a total length LR. The massage roller total length LR can be 21 inches.

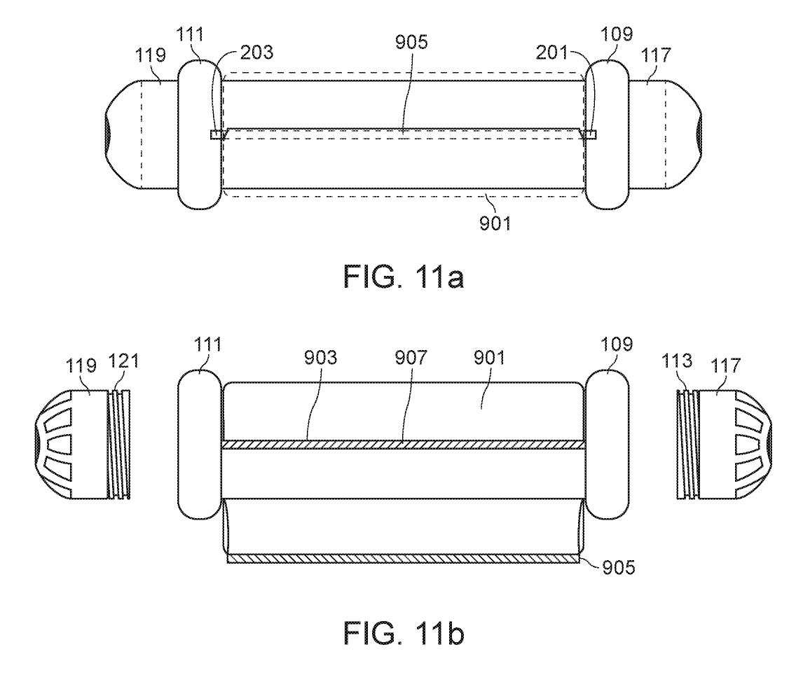

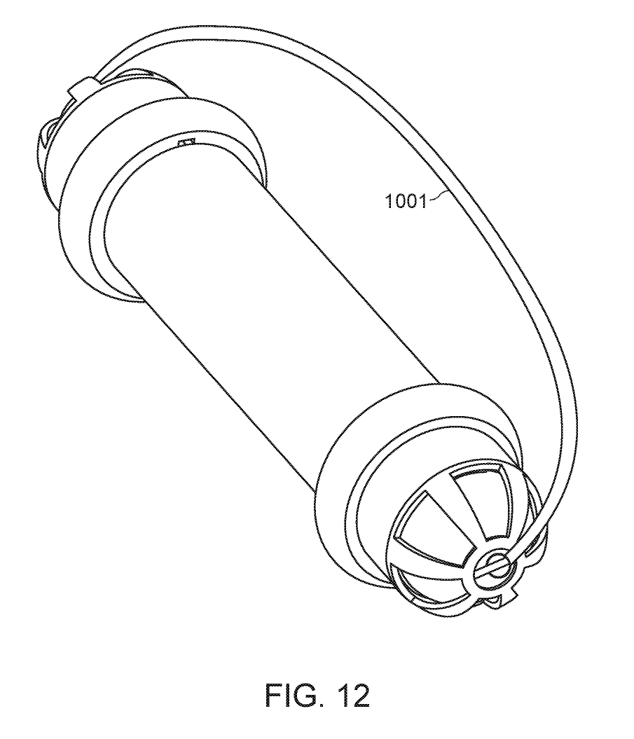

The rolling supports 109, 111 aid in the use of the tube 101 as a massage roller. Traditional massage rollers quickly become extremely unsanitary because the entire surface of the massage roller touches the dirty floor when in use. The dirt and germs are readily transferred from the floor to the roller and then to the user. In contrast, when the present invention is used as a massage roller, the rolling supports 109, 111 are all that touches the floor or other surface when the exercise mat carrier 100 is rolled against a portion of the body of a user and the floor or other surface. In this way the outer tube wall 105, or any other material covering the outer tube wall 105, such as the removable and replaceable flexible cover 901 described below with reference to FIG. 11, remain clean and sanitary. In the illustrated embodiment the rolling supports 109, 111 are substantially identical, but in other embodiments they can have differences.

FIG. 4 is a diagrammatic cutaway view along the line A-A (see FIG. 2) of one of the ring-shaped rolling supports 111. In one embodiment, the rolling support 111 is a single piece, injection molded ring, constructed of lightweight delrin, nylon, suitable plastics or lightweight, durable, non-scratch, non-marking polymers. Other materials can also be used as would be appreciated by those skilled in the art.

The rolling support 111 can have an outer diameter ROD of 7 inches and a width RSH of 2 inches. Passing through the center of the rolling supports is a centered through-hole 401 defined by a through-hole wall 403. The hole 401 has a depth RSH of 2 inches and passes through the rolling support 111. The hole 401 has a through-hole inner-diameter RID of slightly more than 5 inches and can therefore be slid a distance RBD of approximately 1 inch flush onto an end of the tube 101 having an outer diameter OD of 5 inches. The other rolling support 109 can be substantially the same as the rolling support 111 and slid onto the opposite end of the tube 101. The rolling supports 109, 111 can then be affixed to the tube 101 by bonding, a friction pressure fit, or some other means known in the art.

Approximately half of the depth of the hole 401 can be threaded on the through-hole wall 403 and is referred to as female threaded-hole 405. The treaded hole 405 has a depth RTD of 1 inch to accept the 1 inch male threaded necks 113, 121 of the drying modules 117, 119.

The rolling supports 109, 111 each have notches 201, 203, respectively. In FIG. 2, notch 203 can be seen but notch 201 is hidden from view. Both of the notches 201, 203 can be seen in FIG. 11a. FIG. 4 provides a cutaway view of the notch 203. The notches 201, 203 face each other on the opposite rolling supports 109, 111 and function as insertion slots for the cover 901 as described below with reference to FIG. 11.

In another embodiment the rolling supports 109, 111 are injection molded together with the tube 101 as a single piece. In yet other embodiments, more than two rolling supports could be used or they could be positioned along the tube 101 at locations other than opposite ends.

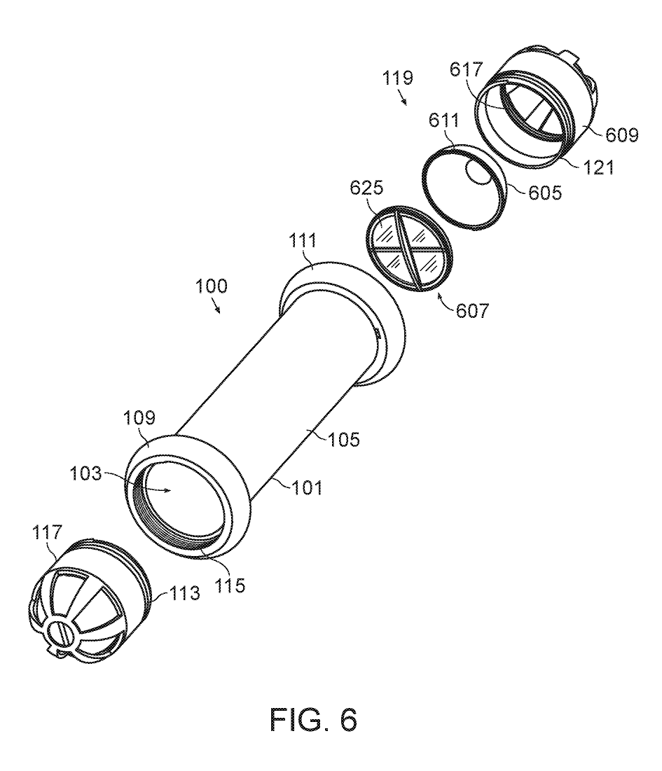

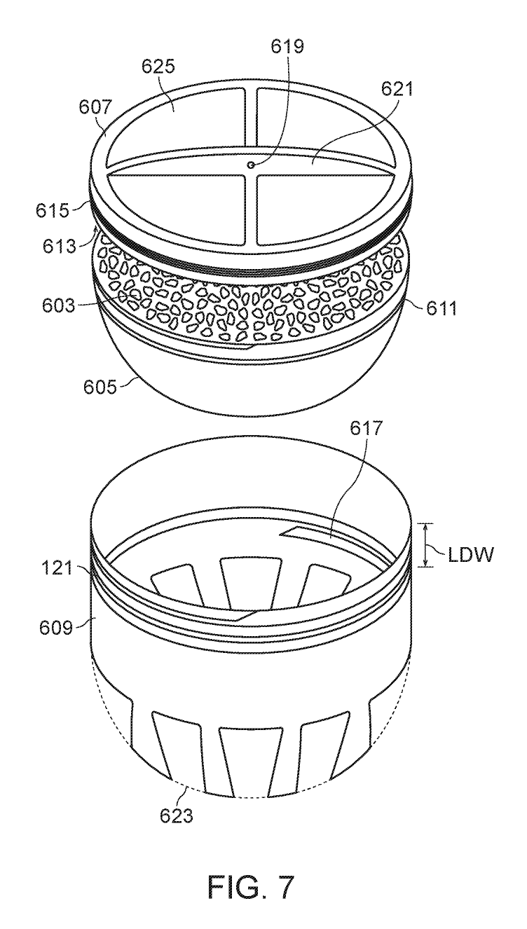

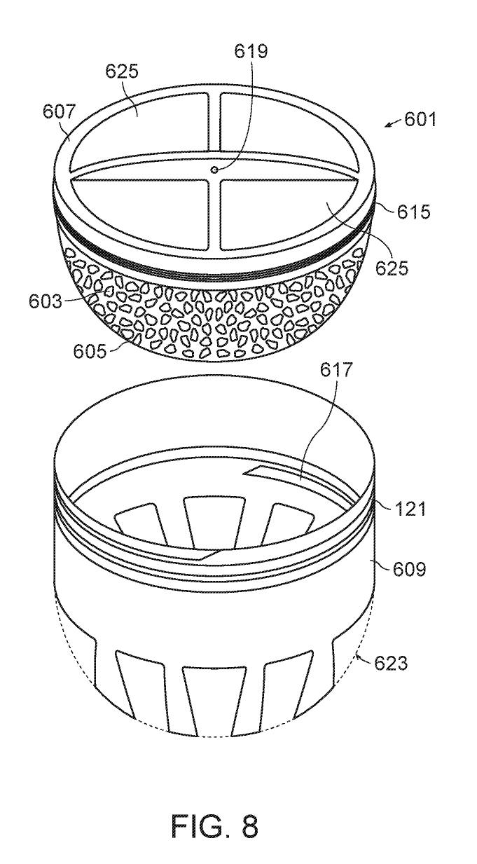

Drying modules 117, 119 (see FIGS. 6, 7 and 8) are containers for holding one or more types of desiccant 603 (see FIGS. 7 and 8). In a preferred embodiment, the desiccant 603 is made up of moisture absorbing silica beads that have the properties of being non-toxic, color changing, saturation indicating, and rechargeable, or any combination of these properties. One preferred desiccant is SORBEAD ORANGE CHAMELEON by ENGELHARD of New Jersey, USA (now BASF). Other desiccants working by means of either adsorption or absorption can also be used. In other embodiments still other drying agents or methods known to those skilled in the art can be used to dry a wet exercise mat 501 within the tube 101 (see FIG. 5). In a preferred embodiment, the degree of moisture uptake is indicated by a color change of the desiccant 603.

In use, the drying modules 117, 119 are fluidly connected with the space 103 in the tube 101 for drying the exercise mat 501. In other embodiments it is possible to use a single drying module 117, rather than the pair of drying modules 117, 119. In such an embodiment the opposite end of the tube would be simply closed off, without a drying module 119.

FIG. 6 shows a perspective view of the exercise mat carrier 100 with the drying modules 117, 119 detached from the main rigid hollow tube and the drying module 119 shown disassembled.

As shown in FIGS. 2 and 6, the drying module 117 has a neck 113 with outer male threads for engaging the inner female threads 115 of the rolling support 109 or alternatively, in another embodiment, for engaging with inner female threads (not shown) of the tube 105 so that when screwed into engagement there is a substantially fluid-tight connection between the inner spaces of the drying module 117 and tube 101. Similarly, the drying module 119 has neck 121 with outer male threads for engaging the inner female threads 405 of the rolling support 111 (see FIGS. 3 and 4). Here, “substantially fluid-tight connection” means that the connection is tight enough so that the desiccant 603 can absorb liquid from the mat 501 at least as fast or faster than a liquid or a gas, such as water vapor, can leak into the space 103 from outside of the exercise mat carrier 100.

FIG. 7 shows a disassembled drying module 117 (or 119). FIG. 8 shows a partially assembled view of the drying module 117 (or 119). A desiccant container 601 fits inside a drying module housing 609 to make up the drying module 117. The desiccant container 601 is made up of a desiccant container bowl 605 and a desiccant container lid 607.

The desiccant container bowl 605 has outer male threads 611 for screwing into inner female threads 613 of the desiccant container lid 607. The desiccant container lid 607 also has outer male threads 615 for screwing into inner female threads 617 of the drying module housing 609.

The bowl 605 of the desiccant container 601 can be transparent or translucent. The bowl 605 and lid 607 can be made from clear recyclable plastic PET or clear microwaveable food-grade silicon, for example. Within the lid 607 can be a catcher 625 to keep the desiccant 603 from falling from the bowl while still allowing moisture to pass into the desiccant container 601 to be removed from the tube 101. The catcher 625 can be a moisture wicking fabric, or can simply be holes in the lid material small enough to prevent the desiccant beads from falling through while big enough to allow moisture to pass through. The bowl 605 is molded to fit flush against the inside surface of the drying module housing 609. The lid 607 has a sturdy hook style twist tab 621 molded into the top for screwing and pulling the desiccant container 601 in and out of the drying module housing 609. The tab 621 can also have a pull-hole 619 through which a string can be threaded to help pull out the desiccant container 601 from the drying module housing 609.

The drying module housing 609 has viewing sections 623 through which the color of the desiccant 603 within the desiccant container 601 can be viewed. As mentioned above, the desiccant 603 changes color according to the degree of moisture absorbed. By viewing the color of the desiccant 603 through the viewing sections 623, a user can determine when the desiccant 603 should be recharged or replaced. The viewing sections 623 can be empty spaces molded or cut into the drying module housing 609, thereby allowing the user to view the desiccant or color of the desiccant through the viewing section 623 and the desiccant container bowl 605. The viewing sections 623 can have different designs as illustrated by the different shapes of the viewing sections 623 in FIG. 5. Alternatively, the viewing sections 623 could be made from a transparent or translucent material allowing the user to view the desiccants or at least the color of the desiccants. In another alternative embodiment, the entire drying module housing 609 can be transparent or translucent, thus making the entire drying module housing a viewing section, and thereby allowing the user to view the desiccant or at least the color of the desiccant.

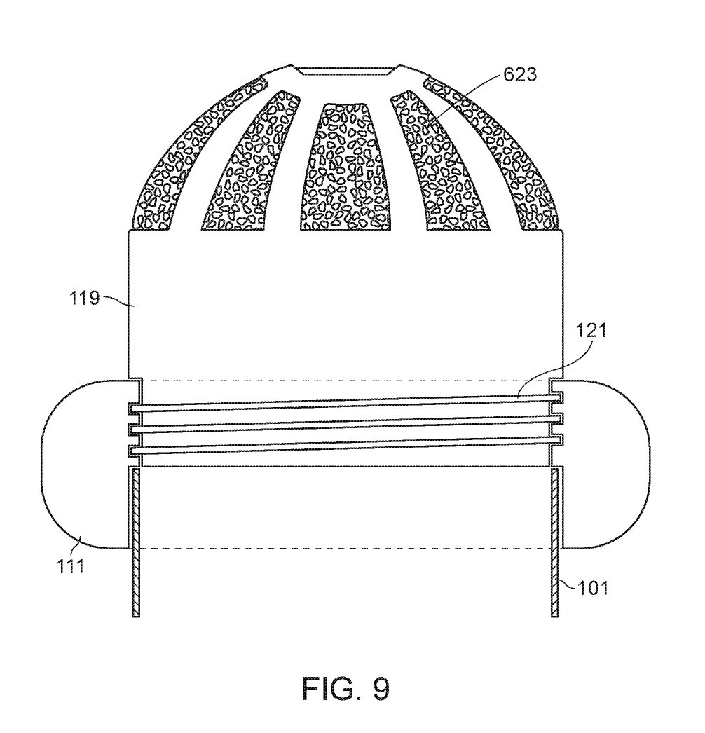

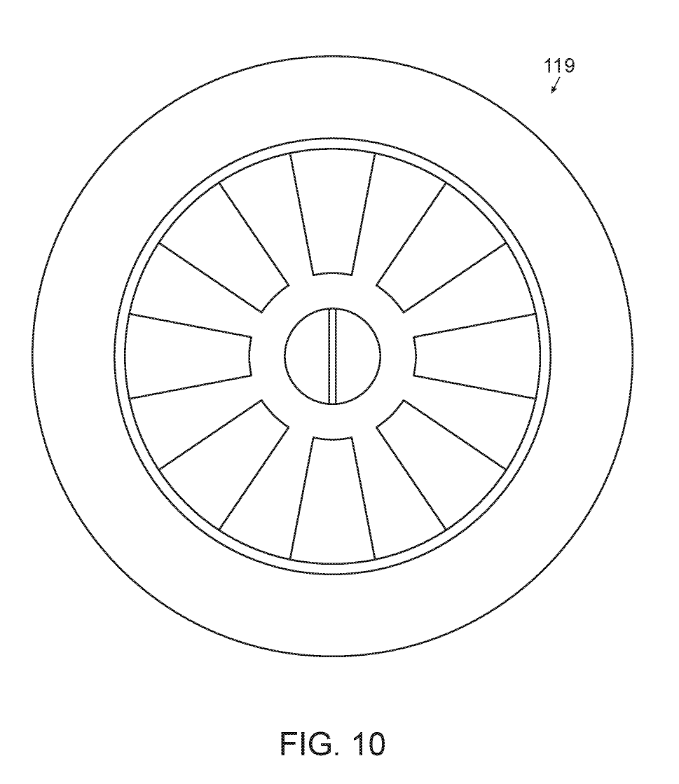

FIG. 9 shows another view of the drying module 119 assembled and attached to the rigid hollow tube 101. FIG. 10 shows a top view of the drying module 119.

In use, the desiccant 603 is first placed within the desiccant container bowl 605. Next, the lid 607 is screwed onto the desiccant container bowl 605 by grabbing onto and twisting the tab 621 (FIGS. 7 and 8). The assembled desiccant container 601 is then placed into and screwed into the drying module housing 609 (also by grabbing onto and twisting the tab 621) to make up the assembled drying module 117 or 119 (FIG. 8). As shown in FIG. 9, the assembled drying module 117 or 119 is then screwed onto the rolling supports 109, 111 and tube 101 to form a substantially fluid-tight connection. As the desiccant 603 adsorbs moisture from the wet exercise mat 501, the user can observe the desiccant 603 through the viewing sections 623. When the color of the desiccant 603 indicates that the desiccant needs to be recharged or replaced, the user unscrews and removes the desiccant container 601 from the rolling supports 109, 111 and tube 101. A string passing through the pull-hole 619 in the tab 621 can also be used to help pull out the desiccant container 601 from the drying module housing 609. Many types of desiccant can be recharged by placing them in a microwave oven. The bowl 605 and lid 607 can be made from a microwaveable material such as microwaveable plastic PET or microwaveable food-grade silicon so that the desiccants 603 do not need to be removed from the desiccant container 601 to recharge them in a microwave oven. Alternatively, some desiccants are rechargeable in a conventional oven in which case the bowl 605 and lid 607 should be made from heat resistant material. When the desiccant needs to be replaced rather than recharged, the bowl 605 and lid 607 can be unscrewed from each other, the used desiccant removed, and new desiccant added.

FIGS. 5a-5c show diagrammatic views of the exercise mat carrier 100 along with the exercise mat 501. The exercise mat 501 can be a standard 24 inch wide by 72 inch long by ¼ inch thick yoga mat. Mats with other dimensions can also be used. Also, instead of a yoga mat, a Pilate's mat, stretching mat, carpet, or other type of mat can be used. The mat can be made of a plastic, rubber, natural fiber or many other possible materials so long as it can be rolled or folded into the exercise mat carrier 100. FIG. 5a shows the rolled-up exercise mat can have a width M which for a standard yoga mat is 24 inches.

Typically after use, the exercise mat 501 is rolled up and can be slid into the space 103 (as shown in FIG. 2) of the tube 101 as shown in FIG. 5b. One or both of the drying modules 117, 119 are unscrewed from the rolling supports 109, 111 and rigid hollow tube 101 to allow the exercise mat 501 to be slid into the space 103 of the tube 101. After the mat 501 is slid into place, the drying modules 117, 119 are screwed back into the rolling supports 109, 111 and rigid hollow tube 101 as shown in FIG. 5c to enclose the exercise mat 501 therein. The exercise mat 501 can extend partially into the drying modules 117, 119 (also shown in FIG. 5c).

FIGS. 11a and 11b show a removable and replaceable flexible cover 901 placed around the outside of the rigid hollow tube 101 aiding in its use as a comfortable massage roller.

The cover 901 wraps around and covers the outer tube wall 105 of the tube 101 between the rolling supports 109, 111. One edge of the cover 901 has a bar 903 passing through it. The bar 903 can be a bendable stainless steel bar or bendable hard-plastic bar, for example. The same edge has a Velcro strip 907. The opposite edge of the cover 901 has another Velcro strip of 905 for fastening to the Velcro strip 907. The cover 901 is wrapped around and secured to the tube 101 by first bending the bar 903 and inserting it into the notches 201, 203. Next, the cover 901 is wrapped around the tube 101 until the Velcro strips 905, 907 match up and can be fastened to each other. Other fastening methods known in the art can be used instead of Velcro or instead of the bar and notches.

To remove the cover 901, the steps are performed in the opposite order. The Velcro strips 905, 907 are unfastened from each other and the cover 901 is unwrapped. The bar 903 is then bent and removed from the notches 201, 203.

The use of the cover 901 has many advantages.

In embodiments where the outer tube wall 105 of the tube 101 is a hard surface. The cover 901 can provide a softer and more comfortable surface for the user to roll against.

Some users like various bumps, textures or materials on the outside of their massage rollers. Thus, the replaceable cover 901 of the present invention can have various bumps, textures or materials. The rolling supports 109, 111 make it possible to use many different bumps, textures or materials on the replaceable cover 901 while maintaining the consistency of the roll when the tube 101 and cover 901 are rolled against a portion of a user's body.

There are prior-art massage rollers with fabric covers. However, in the prior art the fabric covers become very dirty due to rolling directly on the ground and due to the fabric being permanently affixed to the massage roller. In the prior art, if the fabric becomes too dirty or worn out, a whole new massage roller must be purchased due to the fabric being permanently affixed.

However, in the present invention the cover 901 can be easily removed and washed in a washing machine or hand washed. Moreover, in the present invention, the rolling supports 109, 111 keep the cover 901 from touching and picking up dirt from the floor. Generally only sweat from the user will need to be washed from the cover 901. If the cover 901 becomes worn out, a new cover 901 can be put on it, thereby avoiding the waste of needing to replace the entire massage roller as in the prior-art.

Also, the use of the bar 903 inserted into the notches 201, 203 keeps the cover 901 in a fixed position relative to the tube 101, so that it does not slide around the tube 101 as the tube rolls against the user.

In one embodiment, the cover 901 consists of warmable substances that can be heated. For example, flax seeds can be enclosed in material. In this embodiment the cover 901 is placed in a microwave oven to warm up the flax seeds. The cover 901 is then removed from the microwave oven and is wrapped around the tube 101 as described above. The user thus as a therapeutically warm exercise roller to roll against.

FIG. 12 shows a stretching tether 1001 attached to the exercise mat carrier of FIG. 1. The stretching tether 1001 is an adjustable strap and can be made from nylon or any other strong, light and durable fabric. Removable rings, quick releases or carabiners can secure the stretching tether 1001 at each end.

The present invention can conveniently and economically be adjusted to accommodate a wider exercise mat 501 (larger width “M” in FIG. 5a) through the use of one or more extenders.

The extenders can be provided between the rolling supports 109, 111 and drying modules 117, 119, respectively. The extenders can be made from the same material as the tube 101, rolling supports 109, 111, or drying modules 117, 119. The extender is a hollow tube. One end of the extender has male threads to attach to the female threaded holes 115, 405 of the rolling supports 109, 111. The other end of the extender has female threads to attach to the drying module neck with outer male threads 113, 121 (see neck male threads in FIG. 3b).

The exercise mat 501 can extend into the extender and the drying modules 117, 119, thereby allowing for a wider mat 501.

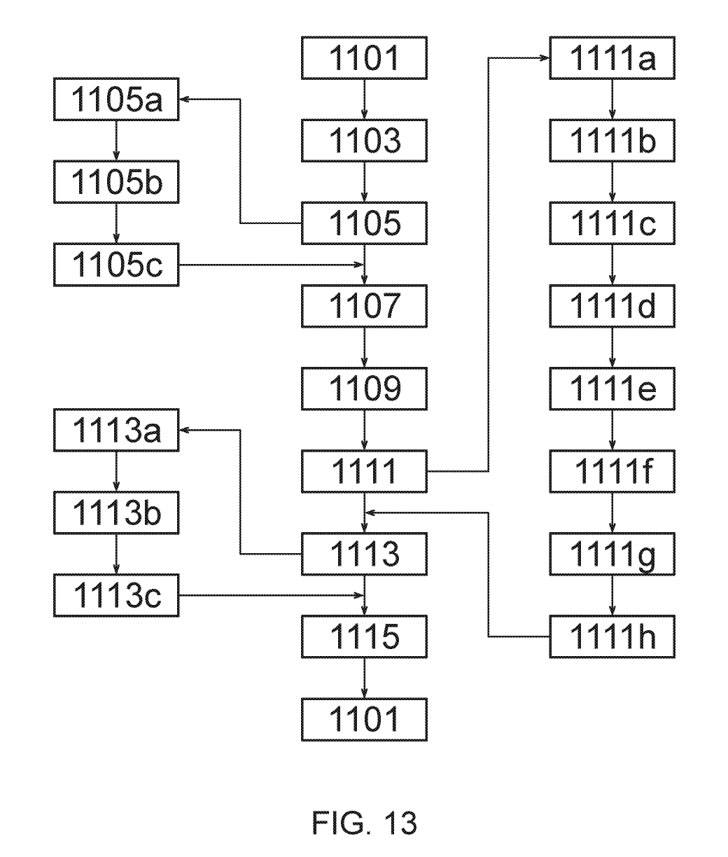

FIG. 13 shows a flowchart for a method 1000 of using the exercise mat carrier of the present invention.

At Step 1101 exercise mat 501 is rolled or folded up.

At Step 1103 the rolled-up exercise mat 501 is placed within the inner space 103 of the rigid hollow tube 101.

At Step 1105 desiccant 603 is placed within at least one of the drying modules 117, 119 to be fluidly connected with the inner space 103 of the rigid hollow tube 101.

Step 1105 also includes the steps of:

Step 1105a of observing a color of the desiccant through the viewing sections 623.

Step 1105b of removing a desiccant container 601 from a drying module when indicated by the color.

Step 1105c of placing desiccant container 601 into a microwave oven to recharge the desiccant 603.

At Step 1107 the rolled-up exercise mat is dried by the desiccant 603 within the drying modules 117, 119.

At Step 1109 the combined exercise mat 501, rigid hollow tube 101 and desiccant 603 are carried by a user.

At Step 1111 the cover 901 is replaced.

Step 1111 also includes the steps of:

Step 1111a of unfastening the Velcro strips 905, 907 from each other.

Step 1111b of unwrapping the cover 901.

Step 1111c of bending the bar 903 and removing the bar 903 from the notches 201, 203.

Step 1111d of removing the cover 901.

Step 1111e of washing the cover 901 or exchanging the cover 901 for a different cover 901.

In an alternative embodiment the Step 1111e can include the Step of heating the cover 901 in a microwave oven, especially when the cover 901 is made up of material surrounding a warmable substance.

Step 1111f of bending the bar 903 and inserting it into the notches 201, 203.

Step 1111g of wrapping the cover 901 around the tube 101.

Step 1111h of fastening the Velcro strips 905, 907 to each other.

At Step 1113 the exercise mat carrier 100 is used as a massage roller.

Step 1113 also includes the steps of:

Step 1113a of separating the drying modules 117, 119 from the tube 101.

Step 1113b of removing the exercise mat 501 from the tube 101.

Step 1113c of rolling the rolling supports 109, 111 on a surface such as the floor while the cover 901 covering the tube 101 is rolled against a portion of the body of a user.

Step 1115 of unrolling or unfolding the exercise mat 501 and placing the exercise mat 501 on a surface. The step can also include using the exercise mat 501 for yoga, Pilates, stretching, or other exercise.

The present invention is not limited to the embodiments illustrated in this specification. For example, the measurements and materials are examples only and modifications that could be made by those skilled in the art are included within the scope of the invention.

In the foregoing specification, the invention has been described with reference to specific exemplary embodiments thereof. The specification and drawings are, accordingly, to be regarded in an illustrative sense rather than a restrictive sense.

1. An exercise mat carrier comprising:
a) a rigid hollow tube enclosing a space for storing an exercise mat;
b) at least one container for holding a desiccant and fluidly connected with the space in the rigid hollow tube for drying the exercise mat; and
c) a flexible cover placed around the outside of the hollow tube allowing for its use as a massage roller.

2. The exercise mat carrier of claim 1, further comprising at least a pair of ring-shaped rolling supports encircling the rigid hollow tube for engaging in rolling contact with a surface when using the rigid hollow tube as a massage roller.

3. The exercise mat carrier of claim 2, wherein the ring-shaped rolling supports prevent the flexible cover from contacting the surface when the ring-shaped rolling supports engage in rolling contact with a surface when using the rigid hollow tube as a massage roller.

4. The exercise mat carrier of claim 2, wherein the flexible cover is microwaveable.

5. The exercise mat carrier of claim 2, wherein the container for holding the desiccant is microwaveable.

6. The exercise mat carrier of claim 5, wherein the container for holding the desiccant is disconnected from fluid connection with the rigid hollow tube and placed directly in a microwave oven to recharge the desiccant.

7. The exercise mat carrier of claim 2, wherein the desiccant within the at least one container is viewable through a viewing section.

8. The exercise mat carrier of claim 2 wherein a color of the desiccant indicating an amount of water adsorbed by the desiccant is viewable through a viewing section.

9. The exercise mat carrier of claim 8, wherein the viewing section is formed within a first container and the desiccant is within a second container which fits within the first container, the first and second containers fluidly connected with the space in the rigid hollow tube for drying the exercise mat.

10. The exercise mat carrier of claim 1, further comprising a stretching tether which can alternatively be used as a strap to carry the assembled exercise mat carrier, or as a stretching tether when removed from the exercise mat carrier.

11. A method for carrying an exercise mat comprising the steps of:
a) rolling up the exercise mat;
b) placing the rolled-up exercise mat within an inner space of a rigid hollow tube, the rigid hollow tube having a flexible cover placed around it for use as a massage roller;
c) placing desiccant within at least one container;
d) fluidly connecting the at least one container with the inner space in the rigid hollow tube;
e) drying of the rolled-up exercise mat by the desiccant; and
f) carrying the combined exercise mat, rigid hollow tube and desiccant.

12. The method of claim 11, wherein the step of carrying the combined exercise mat, rigid hollow tube and desiccant is performed with the aid of a stretching tether supporting the rigid hollow tube.

13. A method for using an exercise mat carrier comprising the steps of:
a) rolling up the exercise mat;
b) placing the rolled-up exercise mat within an inner space of a rigid hollow tube, the rigid hollow tube having a flexible cover placed around it for use as a massage roller;
c) placing desiccant within at least one desiccant container;
d) fluidly connecting the at least one desiccant container with the inner space in the rigid hollow tube;
d) drying of the rolled-up exercise mat by the desiccant;
e) carrying the combined exercise mat, rigid hollow tube and desiccant;
f) disconnecting the at least one desiccant container from the rigid hollow tube;
g) removing the rolled up exercise mat from the inner space of the rigid hollow tube;
h) unrolling the rolled up exercise mat and placing it on a surface;
i) exercising with the exercise mat; and
j) rolling a pair of ring-shaped rolling supports encircling the rigid hollow tube on the surface while the flexible cover around the rigid hollow tube is rolled against a portion of the body of a user as a massage roller.

14. The method of claim 13 further comprising the step of disconnecting the at least one desiccant container from the rigid hollow tube and placing the desiccant container directly in a microwave oven to recharge the desiccant.

15. The method of claim 13 further comprising the steps of:
removing the flexible cover from the rigid hollow tube;
washing the flexible cover; and
wrapping the washed flexible cover around the outside of the hollow tube.

16. The method of claim 13 further comprising the steps of:
removing the flexible cover from the rigid hollow tube;
placing the flexible cover in an oven to warm the flexible cover; and
wrapping the warmed flexible cover around the outside of the hollow tube to provide a therapeutically warm exercise roller to roll against.
